(19) United States
(12) Patent Application Publication
(10) Pub. No.: US 2023/0025408 A1
(43) Pub. Date: Jan. 26, 2023

(54) CUSTOMIZED SOCIAL MEDIA FEED

(71) Applicants: Eric WILSON, Alexandria, VA (US); Joseph POUNDER, Arlington, VA (US); Brian ROGERS, Washington, DC (US)

(72) Inventors: Eric WILSON, Alexandria, VA (US); Joseph POUNDER, Arlington, VA (US); Brian ROGERS, Washington, DC (US)

(21) Appl. No.: 17/870,378

(22) Filed: Jul. 21, 2022

Related U.S. Application Data
(60) Provisional application No. 63/224,073, filed on Jul. 21, 2021.

(51) Int. Cl. G06F 16/9535; G06F 16/9536; G06Q 50/00

(52) U.S. Cl. CPC G06F 16/9535; G06F 16/9536; G06Q 50/01

(57) ABSTRACT

A customized social media feed generation system enables users to create multiple curated social media feeds based on user-specified criteria. A digital content curation system receives user requests, obtains associated digital content form a social media platform, without requiring user intervention. The digital content is passed to the user's device and rendered in a news feed format that includes only the content specified by the user.

### TECHNICAL FIELD

This application relates generally to social media platform technologies in web-based computing environments. Specifically, the disclosed embodiments relate to techniques for creating a customized curated social media feed that provides only specifically defined content to a user for viewing.

### BACKGROUND OF THE INVENTION

Social media platforms enable people across the world to connect, talk, and share content. Shared content can include text, images, videos, sound, and applications data. By posting content to a social media profile, a user can publish various types of digital media for viewing by other users of the social media platform. Each user's personal news feed includes a combination of content posted by other users. This content is generally organized in a temporally linear or topic-specific fashion. The private news feed may display content posted by anyone to whom the user is connected.

Content posted on a social media platform can be reposted or cross-posted to other user profiles. For example, by including “hashtags”, phrases delineated by a leading #, posted content can be cross-posted to a common feed for all content containing the hashtag. Similarly, content can be cross-posted to the profile of another user by including the user's account name in the body of the post along with a signal character such as a “@” thus causing the content to appear along with the identified user account's originally posted material. In this way, content can be shared with and viewed by even those users who are not connected to the originator of the content.

### BRIEF DESCRIPTION OF THE DRAWINGS

FIG. 1 shows a block diagram of a system illustrating a customized social media feed generation system according to embodiments of the present invention.

FIG. 2 shows a block diagram illustrating a user device according to an embodiment of the invention.

FIG. 3 shows a block diagram illustrating a service provider computing device of a digital curation service according to an embodiment of the invention.

FIG. 4 shows a block diagram illustrating a content platform server of a social media platform according to an embodiment of the invention.

FIG. 5 shows a diagram illustrating an exemplary social media feed available via a social media platform.

FIG. 6 shows a call flow diagram of an exemplary method of providing a customized social media feed according to an embodiment of the invention.

FIG. 7 shows a diagram of a customized social media feed according to an embodiment of the invention.

FIG. 8 shows a process flow diagram of an exemplary method for providing a customized social media feed according to an embodiment of the invention.

### DETAILED DESCRIPTION OF THE INVENTION

Prior to discussing embodiments of the invention, some terms can be described in further detail.

A “social media platform” may typically be an entity that provides a cloud-based service by which users can digitally share various forms of expression in an online community. Social media platforms provide applications that enable the sharing of user-generated content such as videos, text, photos, images, audio, and apps. Each user creates a profile visible to other users. The profile contains information about the user. A user interface application provides each user with a feed of content posted by connected users and public groups.

The term “content” may refer to digital expressions. That is, information related to expressions that is stored in a memory in a digital format. Examples of digital content include news articles, videos, songs, photos, artwork, text, charts, maps, ebooks, apps, etc. Thus, information that is stored in digital form and conveys some form of expression may be considered content. Content may be modified over time such as image frames converted taken from a video and saved as a single image file. Content may be transferred to different memories, across networks, and amongst users.

A “content platform server” may be a server computer or a series of server computers that are configured to communicate with various user computing devices and other application servers via a network. The content platform server may communicate with the device using over-the-air (OTA) messages or using any other communication networks and protocols. For example, the content platform server may be configured to provide a communications channel with a device over which information can be transmitted securely to and from the device using a communications network, the Internet, and/or any other relevant communications network. The content platform server may support and enable the provision of a social media platform. Such support can include one or more databases containing for storing content, user account information, and application interface information.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “transceiver” may be a computing device component capable of transmitting and receiving information via a transmission medium. The transmission medium may include wired or wireless communications. For example, transceivers in cellular phone or cellular-enabled mobile devices may enable information exchange over a variety of wireless communications protocols.

A “feed curation service” may be an entity that provides a cloud-based application for the curation and management of a social media feed. The application may enable the collection of posts from a content platform server of a social media platform and the display of those posts in a curated feed format. Curation may be defined by user generated constraints. The feed curation service may organize content obtained from the content platform server according to the constraints. The curated feed is provided to a user via a user interface.

A “service provider computing device” may be a server computer or a series of server computers that are configured to communicate with a content platform server and various user computing devices via a network. The service provider computing device may communicate with the device using OAT or any other communication networks and protocols. The service provider computing device includes multiple databases for storing user account information and content obtained from the content platform server. The service provider computing device includes components to support various application interfaces needed to enable the feed curation application.

A “user computing device” may be any suitable device that can interact with a user. A user device may communicate with the feed curation service and the social media platform. User devices may be in any suitable form. Some examples of user devices include POS devices, cellular phones, PDAs, personal computers (PCs), tablet PCs, wearable devices (e.g., smart watches), vehicles with communication capabilities (e.g., smart cars), etc.

A “user” may include an individual. In some embodiments, a user may be associated with one or more personal accounts and/or user devices. A user may have accounts with a social media platform and a feed curation service.

A “user account” may be a network server location where a user name, token and information needed to provide the user with access to a service is stored. The username and token information may provide a user with access to the service such as a social media platform or a feed curation service. The user account information may include user preferences, privacy settings, social network connections, and optionally content posted by the user.

The various embodiments of the disclosure provide for systems, devices, and methods for creating a customized curated social media feed that provides only specifically defined content to a user for viewing. A service provider, such as a website host, software application provider, web browser plugin, mobile app, etc., may enable the curation of digital content obtained from a social media platform. Social media platforms may include user community interactions via websites, mobile apps, software applications, and the like. The service provider, providing the digital content curation system, may provide a separate and distinct user interface in which content from the social media platform is displayed in a user-specified manner, without requiring the user to visit the social media platform to setup, organize, or view the content or the feed.

The digital content curation system provides users with the ability to specify account names, hashtags, keywords, group names, etc. for content of interest to the user, and group the specified content under a common label name. Anytime the user engages with the digital content curation system, the user may select from previously saved label names to view news feeds of the digital content for the account names, hashtags, group names, etc., associated with that label. The user may have numerous news feeds related to different topics, people, themes, places, or the like. These newsfeeds are implemented and updated by the service provider computing device without requiring the user to engage with the social media platform or manually transfer data between the devices.

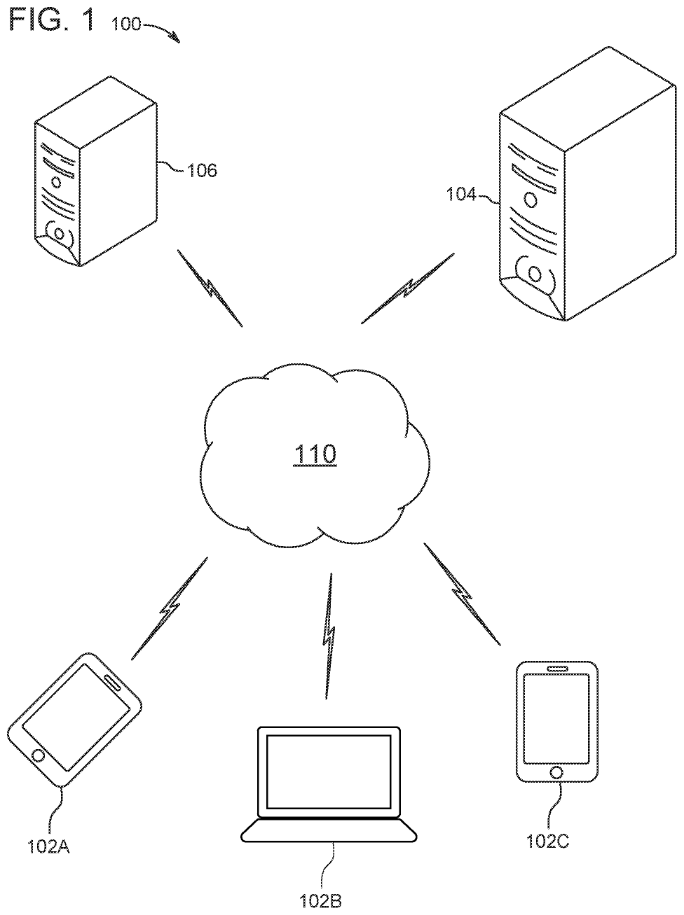

FIG. 1 shows a block diagram of a system 100 comprising a number of components according to some embodiments of the invention. The customized social media feed generation system 100 comprises user devices 102A, 102B, 102C, a service provider computing device 104, a content platform server 106, connected via a network 110 such as the Internet. For simplicity of illustration, a certain number of components are shown in FIG. 1. It is understood, however, that embodiments of the invention may include more than one of each component. For example, there may be any number of content platform servers 106.

The service provider computing device 104 enable digital content curation through the procuring, updating, editing, and otherwise managing of digital content obtained from a social media platform hosted by and associated with content platform server 106. The service provider computing device 104 may obtain digital content from the content platform server 106 in the form of posts, tweets, videos, pictures, audio clips, etc. This digital content may be stored in one or more databases, data lakes, or other storage media of the service provider computing device 104. The database may be stored on the service provider computing device 104 or may be a separate computing device communicatively coupled to the service provider computing device 104.

Both the social media platform and the digital content curation system are accessible via user devices 102A, 102B, and 102C via the network 110. Each user device may engage with the social media platform or the digital content curation system using a variety of user interface options such as websites, mobile applications, software applications, and the like. Users may transmit data to the social media platform in the form of text, pictures, videos, links, audio, etc. The social media platform may convert this information into digital content such as tweets, posts, etc. The digital content curation system may communicate with the content platform server 106 of the social media platform via an application programming interface (API) of the social media platform. Digital content may be requested and transmitted from the social media platform via the API.

The various components may communicate over the network 110, which may include one or more of the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

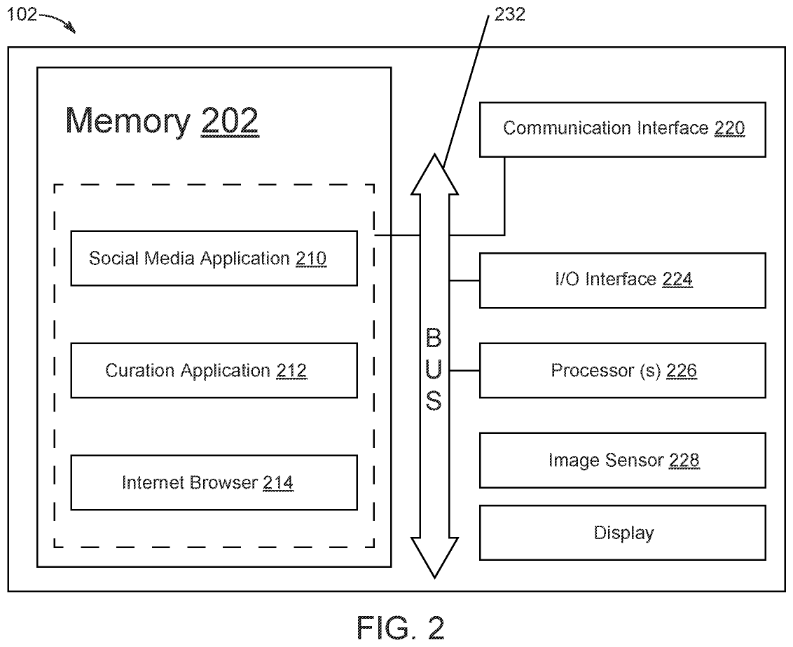

FIG. 2 shows a diagram illustrating an example user device according to an embodiment of the invention. FIG. 2 may be described in reference to a user engaging with a social media platform and a digital content curation system in order to obtain curated digital content. The user device 102 may represent any of user devices 102A, 102B, or 102C from FIG. 1. The user device 102 may have additional components or features according to various implementations of the disclosed embodiments. The illustrated components enable the described functionality of the customized social media feed generation system, but are not intended to be limiting.

The user device 102 includes one or more processor(s) 226 (e.g., ASICs, digital signal processors (DSPs), etc.). That is, the processor 226 can be implemented as one or more integrated circuits (e.g., one or more single core or multicore microprocessors and/or microcontrollers), and is used to control the operation of user device 102. The processor 226 can execute a variety of programs in response to program code or computer-readable code stored in the system memory 202.

The memory 202 can be implemented using any combination of any number of non-volatile memories (e.g., flash memory) and volatile memories (e.g. DRAM, SRAM), EEPROM, or any other non-transitory storage medium, or a combination thereof media. Memory 202 may store a mobile operating system and a mobile application environment where one or more mobile applications reside (e.g. a social media application 210, curation application 212, etc.) to be executed by the processor 226.

Also, the memory 202 may store computer code, executable by the processor 226, for performing any of the functions described herein.

The memory 202 may also store a social media application 210, a curation application 212, and an Internet browser application 214, which may interface with one another to provide the user-side experience of the customized social media feed generation system. For example, the social media application 210 or the Internet browser application 214 may enable the user to engage with the social media platform and participate in content sharing with other users. The curation application 212 or the Internet browser application 214 may enable the user to access the digital content curation system of the service provider computing device 104 to request set up of curated digital content in a customized social media feed.

User device 102 also optionally includes one or more input/output (I/O) interface 224. Example I/O interfaces 224 may include a keyboard and mouse, a touchscreen, a microphone, and one or more buttons (e.g., volume or power buttons, etc.), which may be integrated into a display 240.

The user device 102 further includes one or more communications interfaces 220 which may be wireless and wired. In an example, the communications interface 220 may be optional because some user devices 102 may be configured for wireless communication only). In an example embodiment, if made part of the user device 102, a wired component of communication interface 220 may be used to support wired local connections to peripheral devices (e.g., a USB connection, a mini USB or lightning connection, a headphone jack, graphics ports such as serial, VGA, HDMI, DVI or DisplayPort, audio ports, and so on) and/or to a wired access network (e.g., via an Ethernet cable or another type of cable that can function as a bridge to the wired access network such as HDMI v1.4 or higher, etc.). In another example embodiment, the wireless component of the communications interface 220 includes one or more wireless transceivers for communication in accordance with a local wireless communications protocol (e.g., WLAN or Wi-Fi, WiFi Direct, Bluetooth, etc.) and/or one or more wireless transceivers for communication with a cellular RAN (e.g., via CDMA, W-CDMA, time division multiple access (TDMA), frequency division multiple access (FDMA), Orthogonal Frequency Division Multiplexing (OFDM), GSM, LTE, 4G, 5G LTE, 5G NR or other protocols that may be used in a terrestrial wireless communication subscriber network). The various components of the user device 102 can communicate with each other via a bus 232.

The display 240 may be configured as a touchscreen display, and may be communicatively coupled to peripheral buttons such as a power control button, a volume or vibrate control button, an airplane mode toggle button, etc., and at least one front-panel button such as a Home button, among other components. While not shown explicitly as part of the user device 102, the display 240 can include one or more external antennas and/or one or more integrated antennas that are built into the external casing of the user device 102, including but not limited to Wi-Fi antennas, cellular antennas, satellite position system (SPS) antennas (e.g., global positioning system (GPS) antennas), and the like.

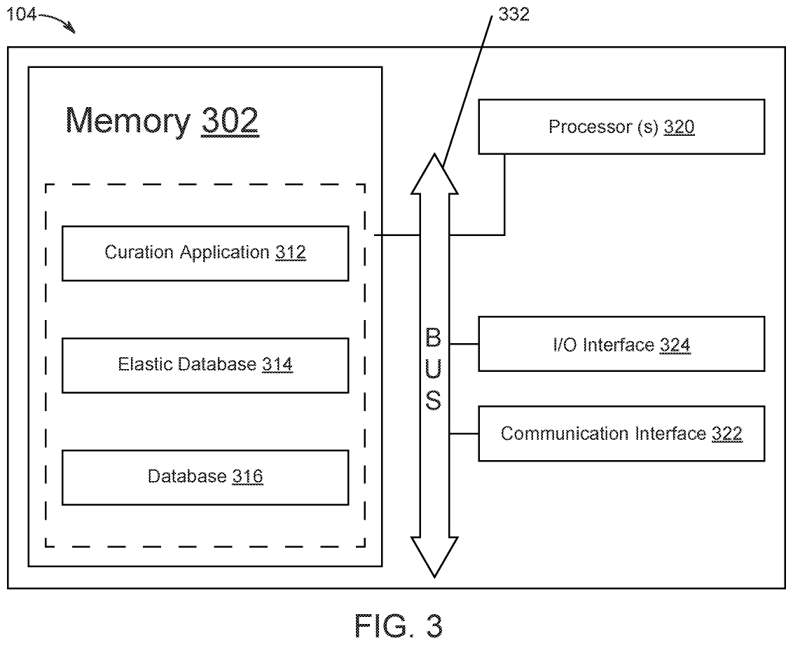

FIG. 3 shows a block diagram illustrating a service provider computing device of a digital content curation service according to an embodiment of the invention. The service provider computing device 104 hosts, supports, maintains, and manages the digital content curation system. The service provider computing device 104 may include multiple servers, computing devices, and network infrastructure components.

The service provider computing device 104 includes a processor 320 coupled to a memory 302, which may include both volatile and non-volatile memory, such as a solid state, or disk drive. The service provider computing device 104 may also include a floppy disc drive, compact disc (CD) or DVD disc drive coupled to the processor 320. The service provider computing device 104 may also include communication interface(s) 322 coupled to the processor 320 for establishing data connections with a network 110. An input/output (I/O) interface 324 may include output circuitry configured to present data and input circuitry configured to receive local user input. The various components of the service provider computing device 104 may be communicatively coupled via system bus 332.

The memory 302 may be a computer-readable storage medium and may store a curation application 312, an elastic database 314, and a database 316. The curation application 312 may comprise instructions for instructing the one or more processors 320 to receive and process service request messages, generate content request messages, receive and manage digital content, and generate customized social media feeds including a portion of the digital content. Digital content and user account information may be stored in database 316. Elastic database 314 may store the text portion of digital content to enable rapid search of the digital content.

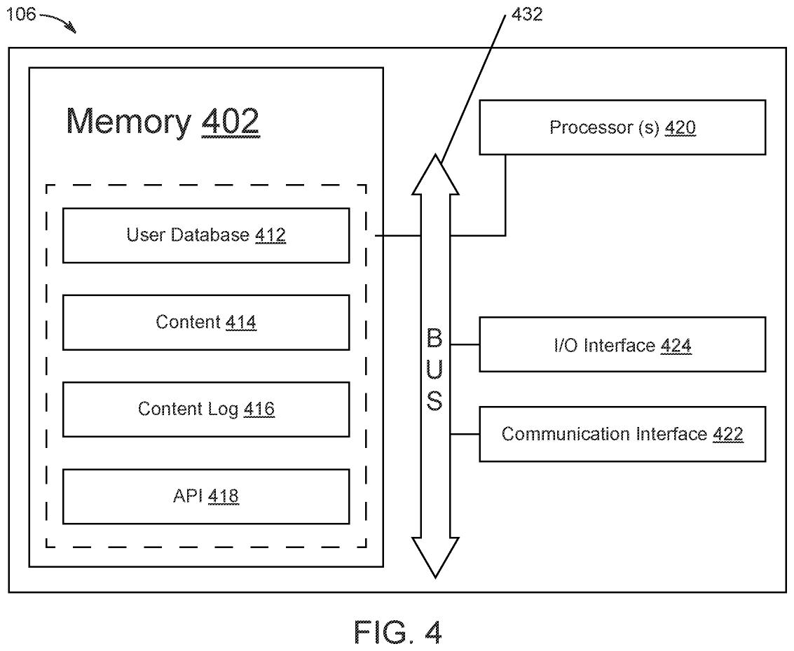

FIG. 4 shows a block diagram illustrating a content platform server of a social media platform according to an embodiment of the invention. The content platform server 106 hosts, supports, maintains, and manages a social media platform. The content platform server 106 may include multiple servers, computing devices, and network infrastructure components necessary to host the social media platform.

The content platform server 106 includes a processor 420 coupled to a memory 402, which may include both volatile and non-volatile memory, such as a solid state, or disk drive. The content platform server 106 may also include a floppy disc drive, compact disc (CD) or DVD disc drive coupled to the processor 420. The service content platform server 106 may also include communication interface(s) 422 coupled to the processor 420 for establishing data connections with a network 110. An input/output (I/O) interface 424 may include output circuitry configured to present data and input circuitry configured to receive local user input. The various components of the content platform server 106 may be communicatively coupled via system bus 432.

The memory 402 may be a computer-readable storage medium and may store a user database 412, digital content 414, a content log 416, and an application programming interface 418 among other data components and applications. The user database 412 may store and maintain information in association with user account for the social media platform. Such information may include account names, profile photos, profile descriptions, links to other account names owned by the user, etc. The digital content 414 may be the various media posted by and, or created by users of the social media platform. This may include posts, photos, videos, audio, text, graphics, and other digital content submitted by users to the social media platform. One or more content logs 416 may enable or facilitate the provision a chronologically ordered media feed for users of the social media platform. The content log 416 may be an algorithm, application, or other processor-executable instructions that organize digital content for display. An API 418 may be provided to enable partners of the social media platform to gain access to the digital content 414 and content log 416 of a user existing in the user database 412.

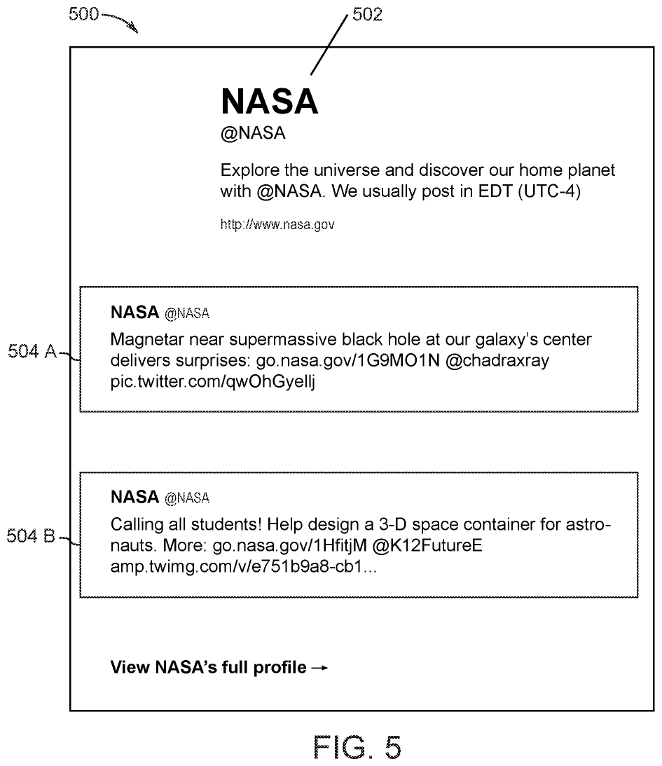

FIG. 5 shows a diagram illustrating an exemplary social media feed available via a social media platform. FIG. 5 may be a screenshot of a mobile app for the social media platform, in which a social media feed generated for a user of the social media platform is displayed. The user's account name 502 or a display name may be positioned near the top of the screen. In the illustrated example, the account name 502 is “NASA.” Below the account name 502, a series of social media posts 504 are displayed in chronological order. The illustrated social media posts 504 include text, hyperlinks to other content, and the “tagging” or inclusion of other user's by providing the account name of another user with the “@” symbol placed directly in front of the account name. In FIG. 5, the social media feed shown reflects posts made by the user “NASA.” A social media feed generated for “NASA” rather than by “NASA” would include a variety of posts and content made by user accounts, hashtags, and groups to which “NASA” subscribes or follows. The structure of the social media posts may be similar to those shown in FIG. 5 but would be made by others.

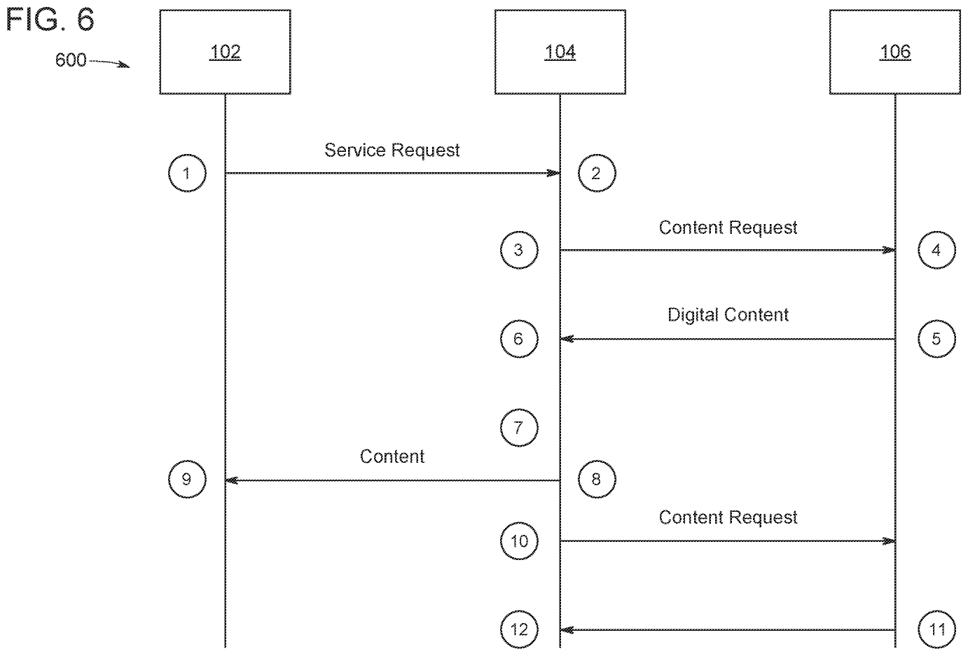

FIG. 6 shows a call flow diagram of an exemplary method of providing a customized social media feed according to an embodiment of the invention. The social media feed may include digital content obtained from the content platform server 106 by the service provider computing device 104, which may curate and organize the digital content into a customized social media feed accessible by the user of a user device 102.

At step 1, the user device may transmit a service request to the service provider computing device. The user, having an account with both the social media platform and the digital content curation system, may submit the service request to the service provider computing device 104 via the communication interface 322. A user may initiate the service request by submitting one or more social media platform account names, hashtags, keywords, or groups that the user would like included in a customized, curated, social media feed. The user may submit these text strings via a user interface of the digital content curation system. The service request may include account names, hashtags, and, or group names.

In some embodiments, the account names, hashtags, keywords, and group names may be entered as part of a “label” creation within the digital content curation system. Users may create labels associated with particular social media content in order to generate a curated social media feed for that label. All account names, hashtags, keywords, and group names associated with the label will be used to generate the curated social media feed for the label. The user may select the label from within an account portion of their user interface for the digital content curation system, to view the most updated version of the customized curated social media feed.

Similar to the labels, users may also create categories within the digital content creation system. A category may reference a plurality of account names for the social media platform. For example, the category “U.S. Senators” may include 100 account names, each associated with the social media account of a U.S. Senator. When a user accesses the category via the user interface of the digital content curation system, a customized curated social media feed is created, containing only digital content created by, or referencing (e.g., tagging or comments) the account names in the category.

Both labels and categories may be stored in the database 316 in association with the user account of the user that created the label or category. Users may modify these labels or categories at any point in time, such as by adding new account names. The addition of the account name may generate a new service request that is transmitted to the service provider computing device 104.

At step 2, the service provider computing device 104 may receive the service request from the user device 102 and may determine whether the requested account names, hashtags, group names, an, or keywords already exist within the digital content curation system. The service provider computing device 104 may search the elastic database 314 for the text of posts made in association with the specified account names, hashtags, keywords, or group names. If the digital content already exists, then the service provider computing device 104 may provide the user with a notification and may skip to step 8.

At step 3, the service provider computing device 104 may generate and transmit a content request to the content platform server 106 of the social media platform. The content request message may be generated by the curation application 312 of the service provider computing device 104 and may contain the specified account names, hashtags, and, or group names provided by the user in the service request. The transmittal of the content request may be facilitated by the communications interface (s) 322 of the service provider computing device 104. The content platform server 106 may receive the content request via its own communication interface 422.

At step 4, the content platform server 106 may fetch digital content associated with the specified account names, hashtags, and, or group names. That is, the digital content 414 and at least a portion of the content log 416 associated with the specified elements may be fetched by the processor 420.

At step 5, the content platform server 106 may transmit the fetched digital content to the service provider computing device 104. This transmittal may be enabled via the API 418, which may establish a connection protocol between third party applications such as the digital content curation system and the social media platform.

At step 6, the service provider computing device 104 may store the received digital content. The digital content itself may be stored in the database 316, with reference to all account names, hashtags, and group names appearing in the digital content. The service provider computing device 104 may also store the text of the social media posts, and only the text, in an elastic database, in association with the account names, hashtags, and group names, appearing in the posts. The elastic database 314 may provide quick and easily searchable lookup of content, while the database 316 provides full archiving of social media posts of interest to users.

At step 8, the service provider computing device 104 may generate and transmit a customized social media feed including only the social media posts and associated digital content that that is related to the user's specified elements. For example, posts made by accounts of U.S. senators, tagging accounts of U.S. Senators, or commented on by accounts of U.S. senators, would appear in the feed generated for the category “U.S. Senators.” The curation application 312 may generate the feed and transmit the curated digital content is transmitted to the user device 102 via communication interface 322.

At step 9, the user device 102 may receive the digital content and render it for display in a news feed format on the display 240. The curation application 212 may receive the digital content via communication interface(s) 220. The curation application may use time stamp information (e.g. metadata) for the digital content, to reproduce the customized curated social media feed. The curation application 213 may enable the display of the social media feed on the display 240 of the user device. Thus, the digital content curation system enables users to view only select digital content deemed relevant to them, without having to parse through extraneous posts. By capturing all of the posts and digital content associated with account names, hashtags, and group names, the digital content curation system further ensures that users will not accidentally miss posts of interest to them due to the large volume of superfluous content.

At step 10, the service provider computing device 104 may update the database 316 and elastic database 314 at regular intervals, or upon request by a user.

At step 11, the service provider computing device 104 may transmit a content request including the account names, hashtags, and group names for which content updates are desired. This may proceed in a manner similar to that of the process at step 3.

At step 11, the content platform server 106 may receive the content request, fetch digital content associated with the elements specified in the content request, and transmit the fetched digital content. The content request may specify a date and time of the last digital content fulfillment, enabling the content platform server 106 to fetch only the digital content occurring after the specified time. And date.

At step 12, the service provider computing device 104 may receive the digital content and store it. As in step 6, the digital content may be stored in the database 316, while the text of the digital content is stored in elastic database 314. A timestamp tracking the last digital content request may be update to reflect the new date and time for digital content receipt associated with the account names, hashtags, and group names.

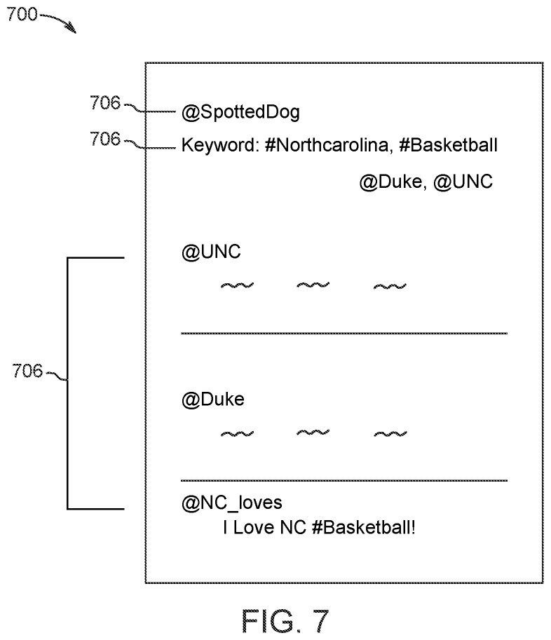

FIG. 7 shows a diagram of a customized social media feed according to an embodiment of the invention. The example screen 700 shown in FIG. 7 may represent the result of following the methods and processes described with reference to FIG. 6. The digital content curation system user name 702 may be displayed on the screen, along with a list of elements 704 included in the customized curated social media feed. In the illustrated example, the list of elements 704 includes the hashtags “#NorthCarolina” and “#Basketball.” Hashtags group together all social media posts that include the hashtag. Thus by including these two hashtags in the list of elements 704, the user is requesting that the resulting customized social media feed include all posts that include these hashtags. The list of elements 704 also includes the account names “@Duke” and “@UNC” indicating that the user would like the resulting customized social media feed to include posts from these user accounts. The user may indicate whether the user would like the list of elements to be inclusive or exclusive. Inclusive feeds include only social media posts that include the indicated list of elements in each post. Exclusive feeds may include all social media posts that at least one of the elements. In an embodiment, the user may specify combinations of inclusive and exclusive elements. Thereby allowing the user to indicate which elements must appear in any digital content within the feed, and those that are desired or optional. The feed 706 illustrates an exemplary configuration of a customized social media feed.

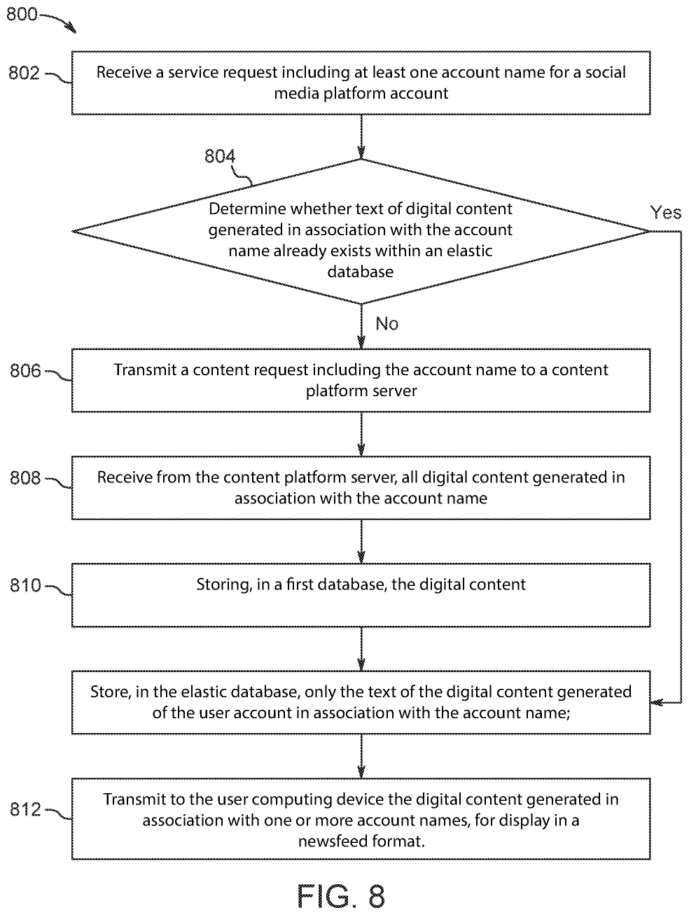

FIG. 8 shows a process flow diagram of an exemplary method for providing a customized social media feed according to an embodiment of the invention. The method 800 may be implemented on the various components illustrated in FIG. 1 of the customized social media feed generation system.

In block 802, the method includes receiving, at a service provider computing device of a feed curation service, a service request from a user computing device, including at least one account name for a social media platform account. The service request may include a label name or category name with which the account name is to be associated. Thus, the method may include storing, in an account database, in association with a user account for a user of the feed curation service, the account name includes storing the account name in association with the label.

In block 804, the method includes, determining, by a processor of the service provider computing device, whether text of digital content generated in association with the account name already exists within an elastic database of the service provider computing device. For example, the processor may query the elastic database, for instances of text of the digital content generated in association with any account names stored in association with the label, and including the keyword. The processor may retrieve, from the first database, the digital content generated corresponding to the result of the query of the elastic database, and transmit, from the service provider computing device, to the user computing device, and the digital content generated corresponding to the result of querying the elastic database, for display in a single newsfeed format.

If block 804 is no, then block 806 executes in response to determining that the text of the digital content generated in association with the account name does not already exist within the elastic database of the service provider computing device. In block 806, the method includes transmitting, by the transceiver of the service provider computing device, a content request including the account name to a content platform server of a social media platform.

In block 808, the method includes receiving, by the transceiver of the service provider computing device, from the content platform server, all digital content generated in association with the account name.

In block 810, the method includes storing, in a first database, the digital content generated by the user account in association with the account name.

In block 811, the method includes storing, in the elastic database, only the text of the digital content generated of the user account in association with the account name and the label name.

In block 812, the method includes transmitting, by the service provider computing device, to the user computing device the digital content generated in association with one or more account names stored in association with the user account, for display in a newsfeed format. This may include the transmission of content associated with a label or category name provided in the service request.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, at a service provider computing device of a feed curation service, a service request from a user computing device, including at least one account name for a social media platform account;
determining, by a processor of the service provider computing device, whether text of digital content generated in association with the account name already exists within an elastic database of the service provider computing device;
in response to determining that the text of the digital content generated in association with the account name does not already exist within the elastic database of the service provider computing device:
transmitting, by the transceiver of the service provider computing device, a content request including the account name to a content platform server of a social media platform;
receiving, by the transceiver of the service provider computing device, from the content platform server, all digital content generated in association with the account name;
storing, in a first database, the digital content generated by the user account in association with the account name;
storing, in the elastic database, only the text of the digital content generated of the user account in association with the account name and the label name; and
transmitting, by the service provider computing device, to the user computing device the digital content generated in association with one or more account names stored in association with the user account, for display in a newsfeed format.

2. The method of claim 1, further comprising:
wherein the service request includes a label; and
storing, in an account database, in association with a user account for a user of the feed curation service, the account name includes storing the account name in association with the label.

3. The method of claim 2, further comprising:
receiving, by the service provider computing device, a query including the label;
retrieving, from the first database, the digital content generated in association with any account names stored in association with the label; and
transmitting, from the service provider computing device, to the user computing device, the digital content generated in association with the account names stored in association with the label, for display in a single newsfeed format.

4. The method of claim 3, wherein the query request further includes a keyword, and the method further comprising:
querying the elastic database, for instances of text of the digital content generated in association with any account names stored in association with the label, and including the keyword;
retrieving, from the first database, the digital content generated corresponding to the result of the query of the elastic database; and
transmitting, from the service provider computing device, to the user computing device, the digital content generated corresponding to the result of querying the elastic database, for display in a single newsfeed format.

5. The method of claim 1, further comprising:
performing, by the service provider computing device, according to a schedule:
generating, by the service provider computing device, a second content request including the account name;
transmitting, by the transceiver of the service provider computing device, the second content request to the content platform server;
receiving, by the transceiver of the service provider computing device, from the content platform server, additional digital content generated in association with the account name;
storing, in the first database, the additional digital content since the last update to the digital content; and
storing, in the elastic database, only the text of the additional digital content since the last update to the text of the digital content in the elastic database.

6. The method of claim 1, wherein the content platform server is a server of a social media platform.

7. The method of claim 1, wherein the digital content includes at least one of a post, a video, a picture, an audio file, and a graphic file.

8. A service provider computing device comprising:
a transceiver;
a memory;
a processor coupled to the memory and the transceiver and including processor-executable instructions that when executed, configures the processor to:
receive, at the service provider computing device implementing a feed curation service, a service request from a user computing device, including at least one account name for a social media platform account;
determine whether text of digital content generated in association with the account name already exists within an elastic database of the service provider computing device;
in response to determining that the text of the digital content generated in association with the account name does not already exist within the elastic database of the service provider computing device:
transmit, by the transceiver of the service provider computing device, a content request including the account name to a content platform server of a social media platform;
receive, by the transceiver of the service provider computing device, from the content platform server, all digital content generated in association with the account name;
store, in a first database, the digital content generated by the user account in association with the account name;
store, in the elastic database, only the text of the digital content generated of the user account in association with the account name and the label name; and
transmit, by the service provider computing device, to the user computing device the digital content generated in association with one or more account names stored in association with the user account, for display in a newsfeed format.

9. The service provider computing device of claim 8, wherein the service request includes a label; and
the processor is configured further to store, in an account database, in association with a user account for a user of the feed curation service, the account name includes storing the account name in association with the label.

10. The service provider computing device of claim 9, wherein the processor is configured further to
receive, by the service provider computing device, a query including the label;
retrieve, from the first database, the digital content generated in association with any account names stored in association with the label; and
transmit, from the service provider computing device, to the user computing device, the digital content generated in association with the account names stored in association with the label, for display in a single newsfeed format.

11. The service provider computing device of claim 10, wherein the query request further includes a keyword, and the processor is configured further to query the elastic database, for instances of text of the digital content generated in association with any account names stored in association with the label, and including the keyword;
retrieve, from the first database, the digital content generated corresponding to the result of the query of the elastic database; and
transmit, from the service provider computing device, to the user computing device, the digital content generated corresponding to the result of querying the elastic database, for display in a single newsfeed format.

12. The service provider computing device of claim 8, wherein the processor is configured further to
perform according to a schedule:
generate a second content request including the account name;
transmit, by the transceiver of the service provider computing device, the second content request to the content platform server;
receive, by the transceiver of the service provider computing device, from the content platform server, additional digital content generated in association with the account name;
store, in the first database, the additional digital content since the last update to the digital content; and
store, in the elastic database, only the text of the additional digital content since the last update to the text of the digital content in the elastic database.

13. The service provider computing device of claim 8, wherein the content platform server is a server of a social media platform.

14. The service provider computing device of claim 8, wherein the digital content includes at least one of a post, a video, a picture, an audio file, and a graphic file.

15. A computer-readable medium having stored thereon processor-executable code that when executed, causes the processor of a service provider computing device to perform steps comprising:
receiving, at a service provider computing device of a feed curation service, a service request from a user computing device, including at least one account name for a social media platform account;
determining, by a processor of the service provider computing device, whether text of digital content generated in association with the account name already exists within an elastic database of the service provider computing device;
in response to determining that the text of the digital content generated in association with the account name does not already exist within the elastic database of the service provider computing device:
transmitting, by the transceiver of the service provider computing device, a content request including the account name to a content platform server of a social media platform;
receiving, by the transceiver of the service provider computing device, from the content platform server, all digital content generated in association with the account name;
storing, in a first database, the digital content generated by the user account in association with the account name;
storing, in the elastic database, only the text of the digital content generated of the user account in association with the account name and the label name; and
transmitting, by the service provider computing device, to the user computing device the digital content generated in association with one or more account names stored in association with the user account, for display in a newsfeed format.

16. The computer-readable medium of claim 15, wherein the service request includes a label; and
the processor further performs the step of storing, in an account database, in association with a user account for a user of the feed curation service, the account name includes storing the account name in association with the label.

17. The computer-readable medium of claim 16, wherein the processor further performs the steps of
receiving, by the service provider computing device, a query including the label;
retrieving, from the first database, the digital content generated in association with any account names stored in association with the label; and
transmitting, from the service provider computing device, to the user computing device, the digital content generated in association with the account names stored in association with the label, for display in a single newsfeed format.

18. The computer-readable medium of claim 17, wherein the query request further includes a keyword, and the processor further performs the steps of
querying the elastic database, for instances of text of the digital content generated in association with any account names stored in association with the label, and including the keyword;
retrieving, from the first database, the digital content generated corresponding to the result of the query of the elastic database; and
transmitting, from the service provider computing device, to the user computing device, the digital content generated corresponding to the result of querying the elastic database, for display in a single newsfeed format.

19. The computer-readable medium of claim 15, wherein the processor further performs the steps of
performing, by the service provider computing device, according to a schedule:
generating, by the service provider computing device, a second content request including the account name;
transmitting, by the transceiver of the service provider computing device, the second content request to the content platform server;
receiving, by the transceiver of the service provider computing device, from the content platform server, additional digital content generated in association with the account name;
storing, in the first database, the additional digital content since the last update to the digital content; and
storing, in the elastic database, only the text of the additional digital content since the last update to the text of the digital content in the elastic database.

20. The computer-readable medium of claim 15, wherein the content platform server is a server of a social media platform.
